(19) United States
(12) Patent Application Publication
(10) Pub. No.: US 2014/0359432 A1
(43) Pub. Date: Dec. 4, 2014

(54) ELECTRONIC DOCUMENT PRODUCTION SYSTEM AND ELECTRONIC DOCUMENT PRODUCTION METHOD THEREOF

(71) Applicant: Wistron Corporation, New Taipei City (TW)

(72) Inventors: JIAN DU, New Taipei City (TW); XING WANG, New Taipei City (TW); CHUN-CHING CHEN, New Taipei City (TW)

(73) Assignee: Wistron Corporation, New Taipei City (TW)

(21) Appl. No.: 14/140,977

(22) Filed: Dec. 26, 2013

(30) Foreign Application Priority Data
May 28, 2013 (CN) 201310203827.8

(51) Int. Cl. G06F 17/24

(52) U.S. Cl. CPC G06F 17/24
USPC 715/255

(57) ABSTRACT

An electronic document production system and an electronic document production method thereof are disclosed. The electronic document production system allows a user to create an electronic document via a network environment. The electronic document production system comprises a user interface and a preview module. The user interface comprises a template management module and a content editing module. The template management module has a template editing module for providing the user to create a template of the electronic document. The content editing module is provided for the user to edit a content of the electronic document based on the template and produce a completed electronic document file. The preview module is provided for the user to preview the content or the template of the electronic document simultaneously while the user is editing.

### BACKGROUND OF THE DISCLOSURE

1. Field of the Disclosure

The present disclosure relates to an electronic document production system and an electronic document production method thereof, and more particularly to an electronic document production system and an electronic document production method that can construct the template by itself.

2. Description of the Related Art

With advances in technology and the rise of the concept of environmental protection, the use of devices such as tablet computers for E-Book packaging has already become a present trend in technological development. E-Book packaging can reduce the use of physical books in order to reduce the burden on students and achieve paperless purposes. Therefore, in the prior art, a variety of electronic document formats, such as the ePUB format and PDF format, have been developed so that users can easily use tablet computers and other devices to read electronic documents. However, the production method of the present template for creating electronic files is quite complicated and the template of electronic documents is fixed styles. As a result, the flexibility of electronic document production is limited, and users who are not familiar with the operation will encounter difficulty in using such documents. Also in the prior art, the user must pre-download the modules to create the electronic file in the tablet PC or the personal computer, which can also cause inconvenience for the user.

Therefore, an electronic document production system and an electronic document production method thereof are needed to solve the shortcomings of the prior art.

### SUMMARY OF THE DISCLOSURE

The main object of the present disclosure is to provide an electronic document production system that can construct the template by itself.

Another object of the present disclosure is to provide an electronic document production method used in the aforementioned system.

In order to achieve the above object, the electronic document production system of the present disclosure is used for a user to create an electronic document via a network environment. The electronic document production system comprises a user interface and a preview module. The user interface, which is provided for the user to edit the electronic document via the network environment, comprises a template management module and a content editing module. The template management module has a template editing module for the user to create a template of the electronic document. The content editing module is provided for the user to edit a content of the electronic document based on the template and create a complete electronic document file. The preview module is provided for the user to preview the electronic document, wherein when the user is editing the content or the template of the electronic document, the preview module previews the edited content or template of the electronic documents simultaneously.

The electronic document production method comprises the following steps: providing a template editing module for the user to create a template of the electronic document; providing a content editing module for the user to edit a content of the electronic document by the template; simultaneously previewing the edited content or the template of the electronic document; and making a complete electronic document file.

### BRIEF DESCRIPTION OF THE DRAWINGS

FIG. 1 is a schematic diagram of the use environment of the electronic document production system of the present disclosure.

FIG. 2 is an architecture schematic diagram of the electronic document production system of the present disclosure.

FIG. 3 is a schematic diagram of the user interface of the present disclosure.

FIG. 4A-4D are schematic diagrams of the template of the electronic documents in different embodiments of the present disclosure.

FIG. 5 is a step flowchart of the electronic document production method of the present disclosure.

FIG. 6 is a step flowchart of one of the embodiments for creating the template of the present disclosure.

### DETAILED DESCRIPTION OF THE PREFERRED EMBODIMENT

To clarify the above and other purposes, features and advantages of this disclosure, a specific embodiment of this disclosure is described in detail with the attached figures as follows.

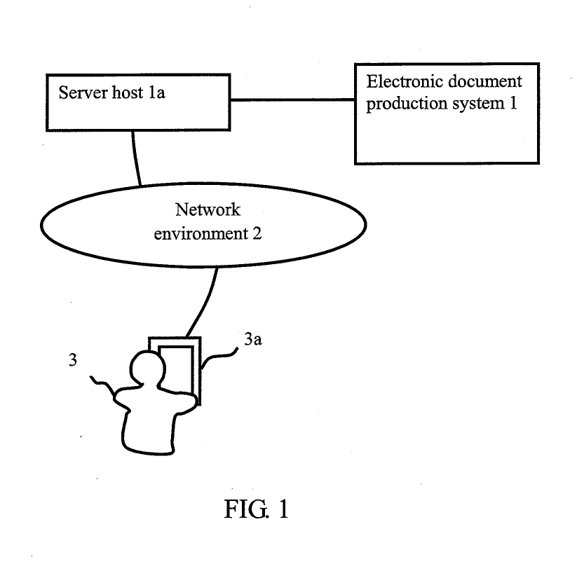

Please refer to FIG. 1, which is a schematic diagram of the use environment of the electronic document production system of the present disclosure.

The electronic document production system 1 of the present disclosure is provided for the user 3 to create the electronic documents. The electronic document production system 1 can be set in a server host 1a to connect to the network environment 2, allowing the user 3 to use an electronic device 3a to connect to the electronic document production system 1 via the network environment 2. The electronic document production system 1 and its internal module can be created by firmware with hardware or software with hardware, but the present disclosure is not limited by this architectural approach. The electronic device 3a can be a tablet, desktop, or notebook computer, or other device, but the disclosure is not limited thus. As long as the electronic device 3a of the user 3 has a browser or other applicable modules, the user 3 can directly connect to the electronic document production system 1 via the network environment 2 without having to download the related program to the electronic device 3a.

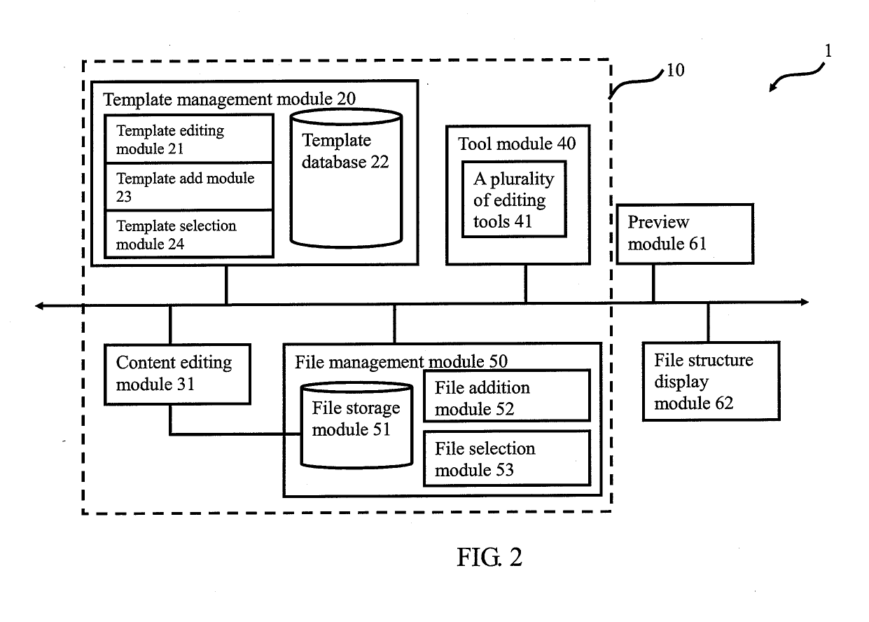

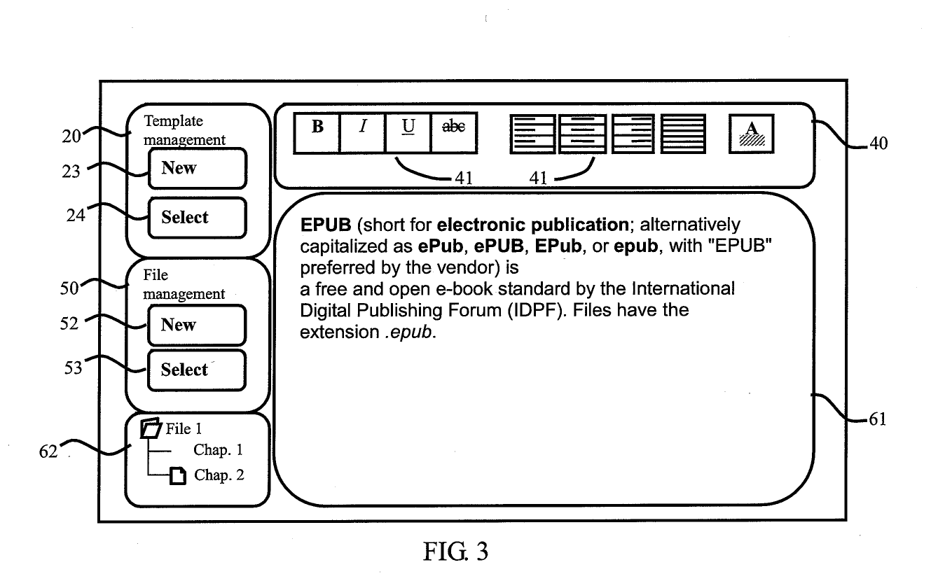

In regard to the detailed framework, please refer to FIG. 2, which presents the architecture schematic diagram of the electronic document production system of the current disclosure, and FIG. 3, the appearance schematic diagram of the user interface of the current disclosure.

The electronic document production system 1 of the present disclosure can comprise a user interface 10 and the preview module 61. The user interface 10 is used for the user 3 to create electronic documents via a network environment 2. The user interface 10 can comprise a template management module 20, a content editing module 31, a tool module 40, a file management module 50, and other modules for the user 3 to use to edit the electronic documents, but the present disclosure is not limited by the above-mentioned modules. The user interface 10 can also have only the most basic template management module 20 and the content editing module 31 to allow the user 3 to edit electronic documents.

The template management module 20 comprises a template editing module 21, a template database 22, a template add module 23, and a template selection module 24. When the user 3 edits the electronic documents, the template editing module 21 of the template management module 20 first allows the user 3 to create the template of the electronic document and to adjust the size and the placement of the elements in the electronic document. After completing the architecture of the template editing module 21, the template editing module 21 can save the template in the template database 22 for the future use of the user 3. The template editing module 21 can edit with the presently-existing Velocity template engine, but the disclosure is not limited thereto. Thus, it is known that the template management module 20 can allow the user 3 to create a new template by the template add module 23. Then, by the use of the template editing module 21, the new template is saved in the template database 22. In addition, the user 3 can also select the saved template by the template selection module 24 for use, or re-create the template by the template editing module 21.

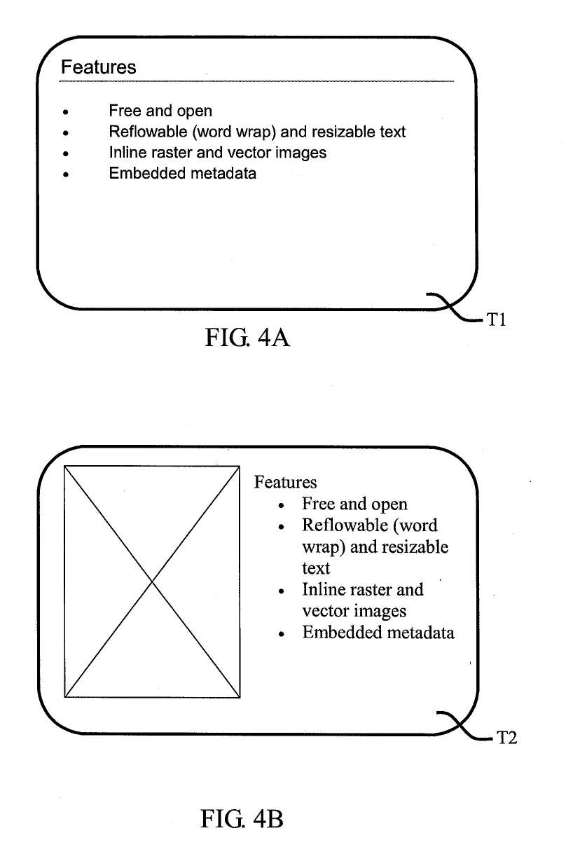

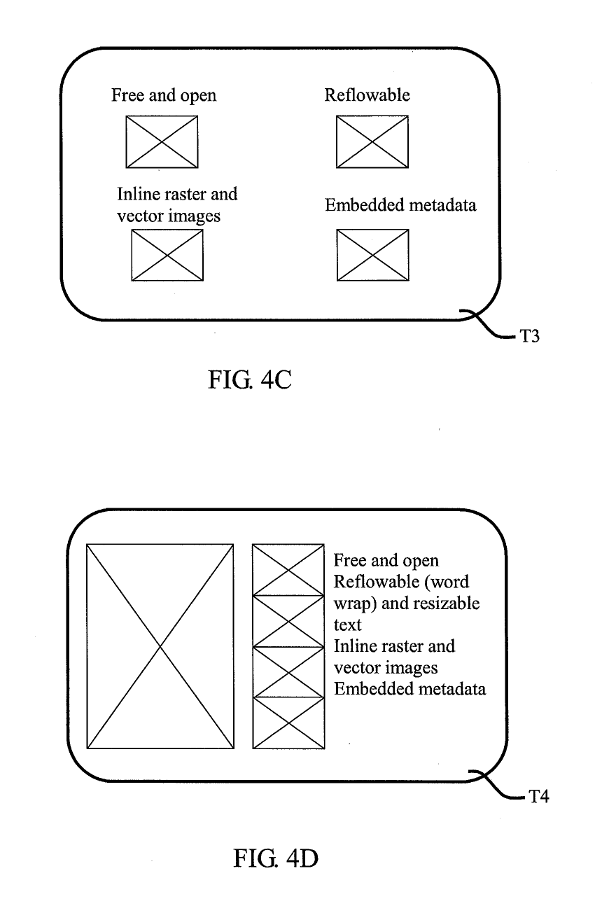

Therefore, please refer to FIG. 4A-4D, which are schematic diagrams of the template of the electronic documents in different embodiments of the present disclosure.

The user 3 can create different templates by using the template editing module 21, such as in FIG. 4A, which has the template T1 with only text. In FIG. 4B, text is combined with the template T2 with large icons. In FIG. 4C, text is combined with the template T3 with small icons, and in FIG. 4D, text is combined with the template T4 with large and small icons. The above-mentioned templates T1, T2, T3, and T4 can be saved in the template database 22 for the user 3 to select and apply. However, the present disclosure is not limited by the above-mentioned templates T1, T2, T3, and T4; i.e., the user 3 can also create templates of other types by using the template editing module 21.

After the template editing module 21 creates the template of the electronic document, the content editing module 31 allows the user 3 to edit the content of the electronic documents based on this template, such as adding a text, an image, an audio, or a video to the template, but the present disclosure is not limited thereto. Therefore, after the editing with the content editing module 31 is complete, a completed electronic document file can be obtained. In addition, the user interface 10 can comprise a tool module 40 that has a plurality of editing tools 41. The plurality of editing tools 41 are used to edit a typography, a font, or a color of the content or the template of the electronic document. Therefore, the user 3 can more easily edit the content or template by using the plurality of editing tools 41. Since in the relevant editing modules, the use of editing tools to assist editing has been widely applied and is not the focus of the present disclosure, the principles will not be described here.

It shall be noted that the template editing module 21 and the content editing module 31 can comprise various additional elements, such as the text, the image, the audio, and the video, by using eXtensible HyperText Markup Language (XHTML) to edit the template and contents of the electronic document. Finally, the content editing module 31 combines multiple XHTML format files into a complete electronic document file to save it as an electronic book-standard file, such as the EPUB3 file format, to facilitate the user 3 to use the electronic device 3a for reading. However, it is noted that the above-mentioned formats are only for illustrative purposes; the disclosure is not limited to only the above-mentioned XHTML format and EPUB3 format files.

The file management module 50 is used to manage the complete electronic document file. The file management module 50 comprises a file storage module 51, a file addition module 52, and a file selection module 53. The file storage module 51 is electrically connected to the content editing module 31. The completed electronic document files made by the content editing module 31 are stored directly in the file storage module 51. The file addition module 52 allows the user 3 to add a new electronic document file, and then by the template editing module 21 and the content editing module 31, the template and the content of the electronic document can be edited. In addition, when the user 3 reads a completed electronic document file, the file selection module 53 can allow the user 3 to select a completed electronic document file for reading from the file storage module 51 or to re-edit the content by the content editing module 31.

The electronic document production system 1 can have a preview module 61, which has the function of displaying the electronic document, allowing the user 3 to directly see the edited electronic files. Therefore, when the user 3 edits the template and the content of the electronic document by the template editing module 21 and the content editing module 31, the user 3 can preview the edited template and the content by the preview module 61 so that the user 3 can operate the user interface 10 more intuitively. In addition, if the user 3 uses the template add module 23 or the template selection module 24 to add or select the template, or if the user uses the file addition module 52 or the file selection module 53 to add or select the electronic document, the user 3 can use the preview module 61 to preview the electronic document to be opened.

In addition, the electronic document production system 1 can also have a file structure display module 62. When the user 3 edits a document in any type of the above-mentioned modules, the file structure display module 62 can use the tree view to represent the opened or created hierarchy of the electronic document, such as showing the chapters in the created electronic document, but the present disclosure is not limited thereto.

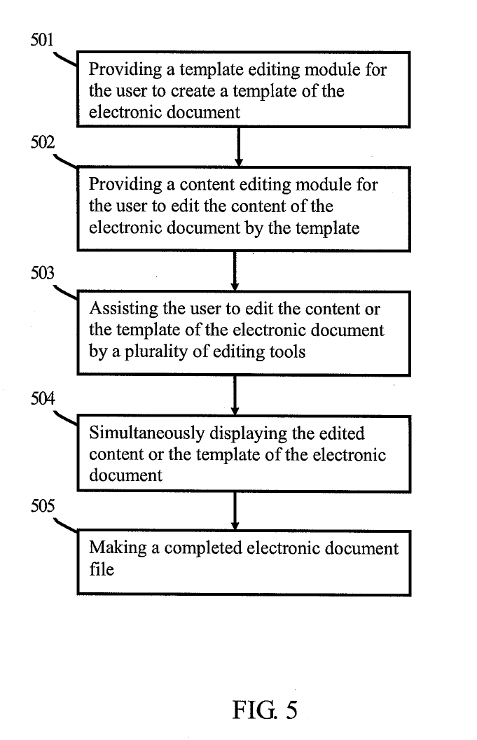

Next, please refer to FIG. 5, which is a step flowchart of the electronic document production method of the present disclosure. It should be noted here that, although in the following, the electronic document production system 1 is used as an example to describe the real-time monitoring method of the present disclosure, the electronic document production method of the disclosure is not limited by the electronic document production system 1.

First, Step 501 is performed: providing a template editing module for the user to create a template of the electronic document.

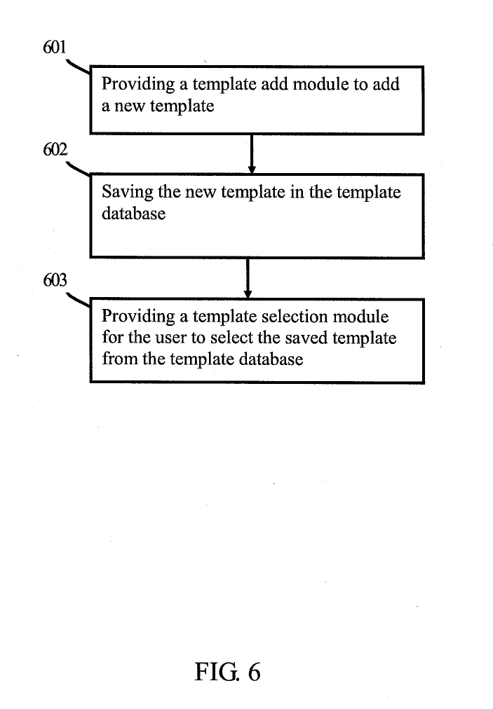

First, when the user 3 wants to create the electronic file, the user 3 can operate the user interface 10 via the network environment 2. Therefore, the template editing module 21 of the template management module 20 first allows the user 3 to create the template of the electronic document and to adjust the size and the placement of the elements in the electronic file. After the document has been created by the template editing module 21, the template editing module 21 can save the template in the template database 22 for the future use of the user 3. One embodiment of the creation of templates by the user 3 of the present disclosure will be described in the explanation of FIG. 6, so it will not be described here.

Next, Step 502 is performed: providing a content editing module for the user to edit the content of the electronic document by the template.

After the template editing module 21 creates the template, the content editing module 31 is used by the user 3 to edit the content of the electronic document based on the template, such as adding a text, an image, an audio, or a video under the template, but the present disclosure is not limited thereto.

Simultaneously, Step 503 is performed: assisting the user to edit the content or the template of the electronic document by a plurality of editing tools.

While Step 501 and Step 502 are performed, a plurality of editing tools 41 can be provided. The plurality of editing tools 41 are used to edit a typography, a font, or a color of the content or the template of the electronic document, so the user 3 can more easily edit the content or template by using the plurality of editing tools 41. The template or the contents of the electronic document can be edited with the XHTML format such that a variety of elements, such as the text, the images, the audio, and the video, can be easily added, but the disclosure is not limited thereto.

Then, Step 504 is performed: simultaneously displaying the edited content or the template of the electronic document.

When the user 3 edits the template and the content of the electronic document by the template editing module 21 and the content editing module 31, the preview module 61 can simultaneously display the edited template and content so that the user 3 can operate the user interface 10 more intuitively.

Finally, Step 505 is performed: making a completed electronic document file.

Finally, the user 3 uses the content editing module 31 to complete the editing, and a completed electronic document file can be obtained. For example, the content editing module 31 combines multiple XHTML format files into a completed electronic document file to save as a standard e-book file, such as a file in the EPUB3 file format. However, the present disclosure is not limited by the special format mentioned above.

Next, please refer to FIG. 6, which is a step flowchart of one of the embodiments for creating the template of the present disclosure. It is noted that Steps 601-603 are used only to illustrate one embodiment of creating the template in Step 501, but the present disclosure is not limited only to the creation of the template according to Steps 601-603.

First, Step 601 is performed: providing a template add module to add a new template.

The template management module 20 provides a template add module 23 for the user 3 to create a new template, and the user 3 can use the template editing module 21 to create the new template.

Next, Step 602 is performed: saving the new template in the template database.

When the template is created in the template editing module 21, the template is saved in the template database 22.

Finally, Step 603 is performed: providing a template selection module for the user to select the saved template from the template database.

Finally, when a new e-file is to be created, the template management module 20 provides the template selection module 24 to allow the user 3 to select the saved template from the template database 22 for direct use by the template selection module 24, or to re-create the template by the template editing module 21. Then Step 502 can be further performed to edit the contents of the electronic documents.

It should be noted that the electronic document production method of the present disclosure is not limited by the abovementioned steps, which can be changed as long as the purpose of the present disclosure can be reached.

With the electronic document production system 1 of the present disclosure and related steps, the user 3 can intuitively create an electronic document and change the template of the electronic document. In addition, the user 3 can connect to the electronic document production system 1 via the network environment 2 without the need to download complicated applications, which facilitates use of the system by the user 3.

In summary, regardless of the purposes, means and effectiveness, this disclosure has characteristics that are quite different from the characteristics of known technology. However, it is noted that many of the above-mentioned embodiments are only for illustrative purposes; the claims of this disclosure should depend on the claims rather than be limited to the embodiments.

What is claimed is:

1. An electronic document production system for a user to create an electronic document via a network environment, comprising:
a user interface, which is provided for the user to edit the electronic document via the network environment, comprising:
a template management module, which has a template editing module for the user to create a template of the electronic document;
a content editing module, which is provided for the user to edit a content of the electronic documents based on the template and create a completed electronic document file; and
a preview module, which is provided for the user to preview the electronic document, wherein when the user is editing the content or the template of the electronic document, the preview module previews the edited content or template of the electronic documents simultaneously.

2. The electronic document production system as claimed in claim 1, wherein the user interface comprises a tool module which has a plurality of editing tools for editing the content or the template of the electronic document.

3. The electronic document production system as claimed in claim 2, wherein the plurality of editing tools comprise tools used to edit a typography, a font, or a color of the content or the template of the electronic document.

4. The electronic document production system as claimed in claim 1, wherein the template management module further comprises a template database electrically connected to the template editing module which saves the created template in the template database.

5. The electronic document production system as claimed in claim 4, wherein the template management module further comprises:
a template add module, which is used to add a new template and save the new template in the template database; and
a template selection module, which allows the user to select the saved template in the template database.

6. The electronic document production system as claimed in claim 1, wherein the user interface further comprises a file management module with a file storage module, which is electrically connected to the content editing module for storing the completed electronic document file edited by the content editing module.

7. The electronic document production system as claimed in claim 6, wherein the file management module further comprises:
a file addition module, which is used to add a new electronic document; and
a file selection module, which is provided for the user to select at least one template from a plurality of template of the file storage module.

8. The electronic document production system as claimed in claim 1, wherein the user interface uses an XHTML format to edit the content or the template of the electronic document and save the completed electronic document file as an EPUB3 format file.

9. The electronic document production system as claimed in claim 1, wherein the user interface further comprises a file structure display module that displays the hierarchy of the electronic document by a tree view.

10. The electronic document production system as claimed in claim 1, wherein the contents of the electronic document comprise a text, an image, an audio, or a video.

11. An electronic document production method, which is used in an electronic document production system for a user to create an electronic document via a network environment, comprising the following steps:
providing a template editing module for the user to create a template of the electronic document;
providing a content editing module for the user to edit a content of the electronic document by the template;
simultaneously previewing the edited content or the template of the electronic document; and
making a complete electronic document file.

12. The electronic document production method as claimed in claim 11, further comprising the steps of assisting the user to edit the contents or the template of the electronic document by a plurality of editing tools.

13. The electronic document production method as claimed in claim 11, further comprising the steps of editing a typography, a font, or a color of the content or the template of the electronic document.

14. The electronic document production method as claimed in claim 11, further comprising the step of saving the created template in the template database.

15. The electronic document production method as claimed in claim 14, wherein the steps of creating the template further comprise:
providing a template add module to add a new template;
saving the new template in the template database; and
providing a template selection module for the user to select the saved template from the template database.

16. The electronic document production method as claimed in claim 11, further comprising the step of saving the edited complete electronic is document file in a file storage module.

17. The electronic document production method as claimed in claim 11, further comprising the following steps:
using an XHTML format to edit the content or the template of the electronic document; and
saving the completed electronic document file as an EPUB3 format file.

18. The electronic document production method as claimed in claim 11, wherein the steps of editing the content of the electronic document comprise editing a text, an image, an audio, or a video.
